(19) United States
(12) Patent Application Publication
(10) Pub. No.: US 2019/0179215 A1
(43) Pub. Date: Jun. 13, 2019

(54) CAMERA FOR A MOTOR VEHICLE, COMPRISING AN INTEGRALLY FORMED HOUSING TOP PART AND A LENS CARRIER, AS WELL AS MOTOR VEHICLE AND METHOD FOR MANUFACTURING A CAMERA FOR A MOTOR VEHICLE

(71) Applicant: Connaught Electronics Ltd., Tuam, County Galway (IE)

(72) Inventor: Rachel O' Connor, Tuam, County Galloway (IE)

(73) Assignee: Connaught Electronics Ltd., Tuam, County Galway (IE)

(21) Appl. No.: 16/310,120

(22) PCT Filed: Jun. 19, 2017
(86) PCT No.: PCT/EP2017/064907

§ 371 Date: Dec. 14, 2018

(30) Foreign Application Priority Data
Jun. 17, 2016 (DE) 10 2016 111 156.2

(51) Int. Cl. G03B 17/12; G02B 7/02; H04N 5/225

(52) U.S. Cl. CPC G03B 17/12; G02B 7/022; B60R 11/04; H04N 5/2254; H04N 5/2252

(57) ABSTRACT

The invention relates to a camera (4) for a motor vehicle (1), comprising an external housing, which comprises a housing top part (15), in which a lens module of the camera (4) is capable of being received, wherein the lens module (25, 26) comprises a tubelike lens carrier (10), which is integrally formed with the housing top part (15). The invention also relates to a motor vehicle (1) 13 and a method for manufacturing a camera (4).

The invention relates to a camera for a motor vehicle, comprising an external housing, which comprises a housing top part, in which a lens module of the camera is capable of being received. Moreover, the invention relates to a motor vehicle as well as a method for manufacturing a camera.

Cameras, which are arranged in a motor vehicle, are known in multiple embodiments. In this connection it is known that cameras are configured and arranged for the detection of an environment of the motor vehicle. Moreover, however, cameras can also be employed for capturing the interior space of the vehicle and there are correspondingly arranged. In this connection cameras are exposed to the most different influences, which they have to withstand. This relates in particular to strong temperature fluctuations and/or strongly fluctuating environmental influences. Moreover, the cameras due to the vibrations when moving the vehicle are also exposed to mechanical strains, which they have to resist permanently. In particular in this connection it is then also a requirement to still be nevertheless highly functionally operable and to facilitate sufficiently good image capturings, which then can be made available to driver assistance systems or it is analyzed on the basis of these pieces of image information, whether and possibly how a driver assistance system acts.

In such cameras for a motor vehicle, which have an extremely compact setup, it is known that an external housing is configured of separate housing parts, a housing top part and a housing bottom part. These housing parts are joined and in the interior form a receiving space for further components, in particular a lens module and at least one interconnect device.

Such a lens module commonly comprises several optically imaging elements, in particular lenses. In the case of common embodiments of such a camera it is also known that the lens module is arranged at an additional further separate component, namely an end ring, and fastened there. This separate end ring then again is attached on a barrellike or drumlike carrier of the lens module, in which lenses are arranged. In particular in this connection a lens arranged most outwardly along the optical axis of the lens module is held.

Such an embodiment of a camera with regard to the mounting effort and thus with regard to its manufacture and composition is of a complex design.

It is the task of the present invention to provide a camera for a motor vehicle, a motor vehicle, and a method for manufacturing a camera, in which the required mounting effort is reduced.

This task is solved by a camera, a motor vehicle, and a method according to the independent claims.

According to the invention a camera for a motor vehicle comprises an external housing including a housing top part. As housing top part that external housing part is referred to which is arranged along a longitudinal axis of the external housing and thus in “viewing direction” of the camera at the front or further towards a front side end of the external housing than another housing part, in particular a housing bottom part. The housing top part can therefore also be referred to as housing front part of the external housing. In the housing top part a lens module of the camera is capable of being housed.

An essential idea of the invention is to be seen in that the lens module has a tubelike lens carrier, which is integrally formed with the housing top part. The lens carrier is configured for receiving the lens elements in a lens arrangement of the camera. The lens elements apart from a front side end lens element are in particular capable of being all received in the lens carrier or in the mounted end state are received therein. The lens module comprises a lens arrangement and possibly distance elements between lens elements.

By this design the number of components is reduced and position tolerances between two very central individual components with regard to the optical precision of the camera, in particular between the housing top part and the lens carrier, during mounting can thereby be prevented.

It is particularly advantageous that the single-piece component is configured with the tubelike lens carrier and the housing top part as metal injection-moulded component. Thereby also complex shapes can be produced in a manner which is precise in shape and stable. The housing top part thus is configured by powder metallurgical injection moulding.

Preferably, the external housing has a separate end ring. The end ring is in particular integrally formed from metal, in particular from aluminium. It is preferably equipped with an internal thread, whereby for screwing together it is provided with an external thread on an outside of the single-piece component comprising the lens carrier and the housing top part. The end ring holds in particular an external lens element of a lens arrangement in position.

It may also be envisaged that in an alternative embodiment the end ring is integrally formed with the housing top part. Thereby the number of components is once again reduced. The integrated end ring can then be arranged on the end face and an adjacently arranged lens element of the lens module can thereby be held axially. This is in particular facilitated since the end ring extends radially into the channel of the lens carrier and thus an axial slipping out of the front lens element from the channel is prevented.

Preferably the single-piece component with the housing top part and the lens carrier is configured from aluminium.

In particular the housing top part has a basic body and a tubelike attachment adjoining in axial direction and integrally formed with it.

Preferably it is envisaged that the basic body has a cornered, in particular square external geometry. Thus the arrangement on motor vehicle components is improved and also the interior, which is enclosed by the external housing, can then in the cross-section equally be individually designed correspondingly square in the cross-section. Thereby the receiving option for correspondingly shaped circuit carriers is given.

Preferably, it is envisaged that the lens carrier has a rear tube part with a first diameter, and axially adjoining a front tube part with a second diameter that is larger than the first diameter. By the design of the lens module and in particular the lens carrier lenses of various sizes and in particular lenses of various radial extension can be housed so that the imaging properties of the lens module can be individually designed.

Preferably, it is envisaged that the lens carrier extends both in the basic body as well as in the tubelike attachment.

Preferably, it is envisaged that the external housing comprises a housing bottom part that is separate from the housing top part and is capable of being connected with the housing top part. In particular these two housing parts then form the external border of the external housing. The housing bottom part in the context of the understanding set out in the above can also be designated as rear housing part.

Preferably, the camera has at least one imager, which is arranged within the external housing. In this external housing or in the interior of the external housing also the lens module is entirely received.

Further, the invention also relates to a motor vehicle comprising at least one such camera. In particular the camera is arranged on the motor vehicle in such a way that an environmental region of the motor vehicle is captured. The camera preferably is component of a driver assistance system of the motor vehicle. In this connection images, which are captured by the camera, are analyzed and in dependency thereon the driver assistance system carries out its intended function.

Further, the invention also relates to a method for manufacturing a camera for a motor vehicle, in which the camera is designed with an external housing, which is manufactured with a housing top part. A lens module of the camera is introduced into the housing top part. An essential idea of the invention is to be seen in that the lens module is configured to comprise a tubelike lens carrier, wherein the lens carrier is integrally formed with the housing top part, in particular the integrally formed component is manufactured as metal injection-moulded component. The advantages achievable herewith were already set out in the above in the explanation of the camera.

In particular the lens elements are introduced after the manufacture of this single-piece component into the lens carrier. A front end external lens element, which is arranged outside the lens carrier and contacts a front edge of the lens carrier, then is made to contact this front edge and by applying, in particular screwing on, the end ring upon the single-piece component, comprising the lens carrier and the housing top part, this end lens is held in position.

Advantageous embodiments of the camera are to be seen as advantageous embodiments of the method according to the invention, wherein in this connection the individual manufacturing or mounting steps in each case can then be effected individually.

Further features of the invention derive from the claims, the figures, and the description of the figures. The features and feature combinations mentioned previously in the description, as well as the features and feature combinations named in the following in the description of the figures and/or shown in the figures alone, are employable not only in the respectively indicated combination, but also in other combinations, without departing from the scope of the invention. Thus also embodiments of the invention are to be considered as being comprised and disclosed, which are not explicitly shown and explained in the figures, but derive by separated feature combinations from the explained embodiments and can be generated therefrom. Also embodiments and feature combinations are to be considered as being disclosed, which thus do not comprise all features of the originally formulated independent claim. Moreover embodiments and feature combinations are to be considered as being disclosed, in particular through the embodiments set out in the above, which go beyond the feature combinations set out in the back-references of the claims or deviate therefrom.

Embodiments of the invention are set out in more detail in the following by reference to the schematic drawings.

These show in:

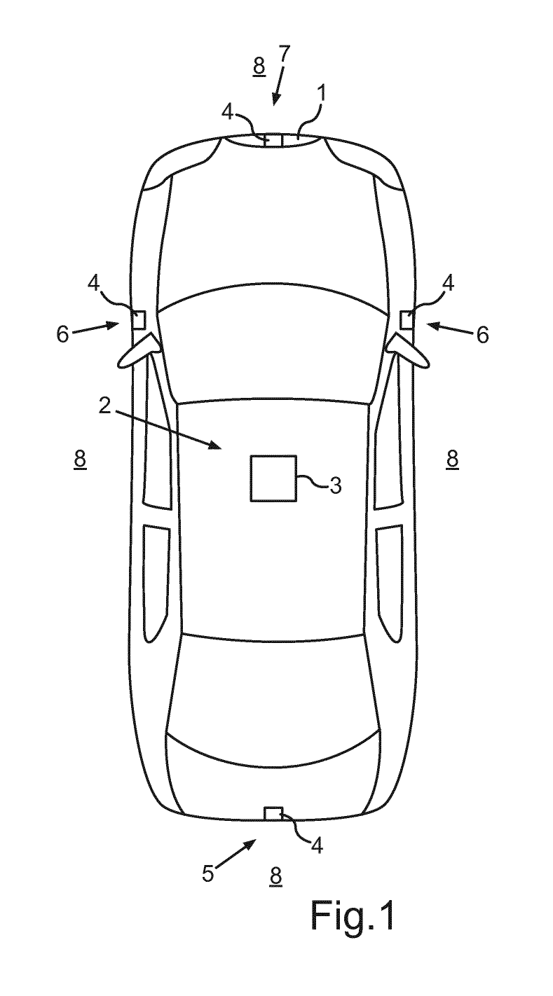

FIG. 1 a schematic top view of an embodiment of a motor vehicle according to the invention with an embodiment of a camera according to the invention;

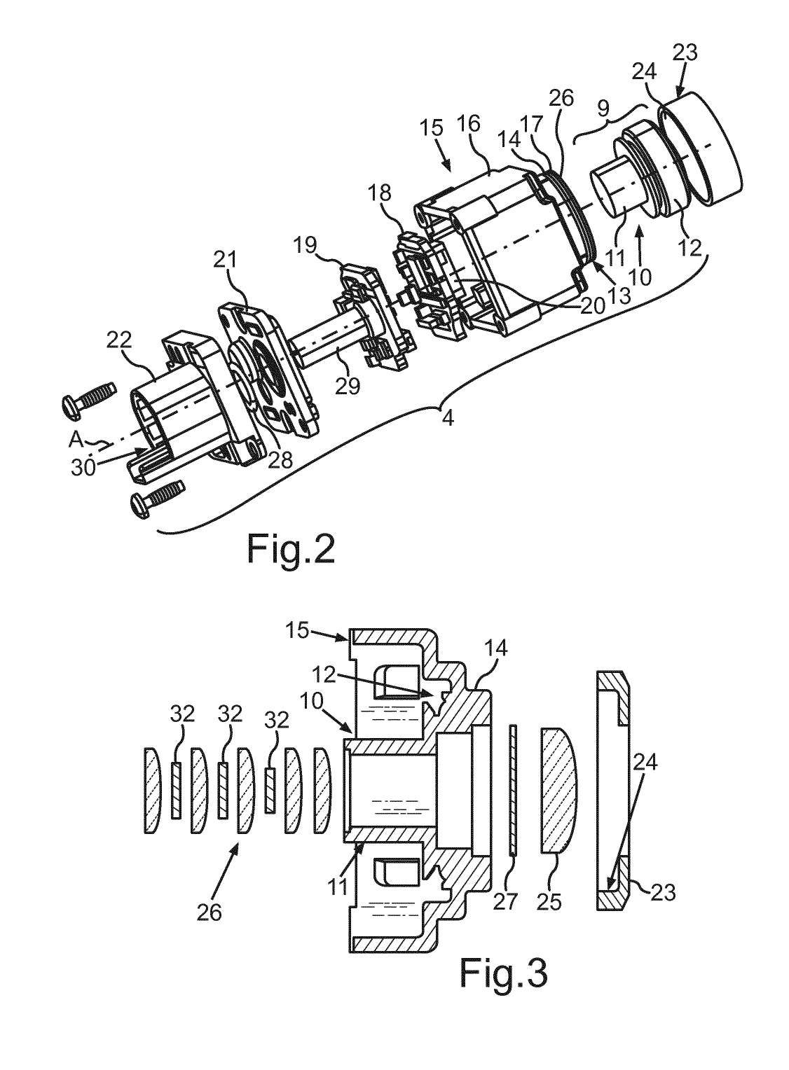

FIG. 2 an exploded view of a known camera;

FIG. 3 a sectional view of a partial area of an embodiment of a camera according to the invention, wherein the components of the partial area are shown in an exploded view;

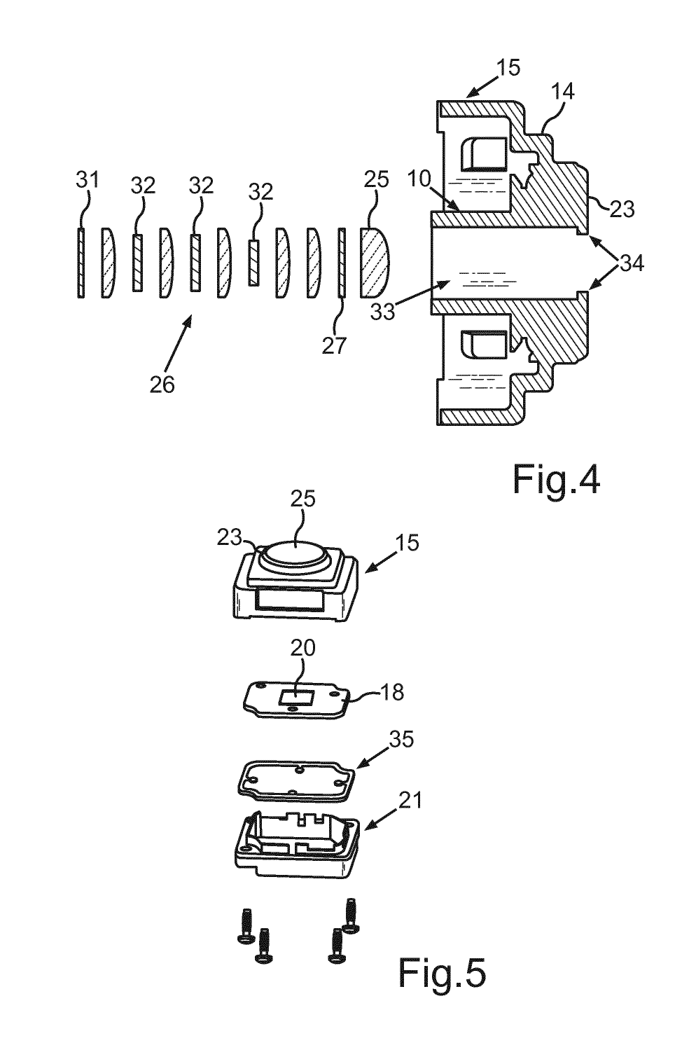

FIG. 4 a sectional view of a further embodiment of a camera according to the invention, wherein the components are shown in an exploded view; and

FIG. 5 an exploded view of an embodiment of a camera according to the invention.

In the figures same elements or elements having the same functions are equipped with the same reference signs.

FIG. 1 shows a motor vehicle 1 according to an embodiment of the present invention in a top view. The motor vehicle 1 in the present case is configured as passenger car. The motor vehicle 1 comprises a driver assistance system 2. The driver assistance system in turn comprises a control device 3, which can for instance be formed by an electronic control device of the motor vehicle 1. Moreover, the driver assistance system 2 comprises at least one camera 4. In the present embodiment the driver assistance system 2 comprises four cameras 4, which are arranged distributed on the motor vehicle 1. Presently, one of the cameras 4 is arranged in a rear portion 5, one of the cameras 4 is arranged in a front portion 7 of the motor vehicle 1, and the remaining two cameras 4 are arranged in a respective lateral portion 6, in particular in one portion of the side mirrors. The number and arrangement of the cameras 4 of the driver assistance system 2 in the present case is to be understood merely as example. Additionally or instead also at least one camera can be provided, which is configured and arranged for capturing an interior space or a passenger compartment of the motor vehicle 1. The cameras are in particular built in to be mounted on an individual motor vehicle component. A motor vehicle component can for example be a bumper or external mirror or a lateral cladding. The motor vehicle component can for instance also be a ceiling liner or an interior lining or a cover of a steering wheel centre or an interior mirror. The motor vehicle components are to be understood merely as examples and also other motor vehicle components can be given. This merely expresses the fact that a motor vehicle component can be of the most varied design with regard to its positional arrangement and material configuration.

By the cameras 4 an environmental region 8 of the motor vehicle 1 can be captured. The four cameras 4 are preferably configured to be identical in construction design. In particular an image sequence or video data can be made available by the cameras 4, which describe the environmental region 8. These video data can be transmitted by the cameras 4 to the control device 3. By means of the control device 3 here a display device (not shown here) of the motor vehicle 1 can be controlled so that the video data of the cameras 4 can be shown to the driver. The driver assistance system 2 thus serves for supporting the driver of the motor vehicle 1 in driving the motor vehicle 1. The driver assistance system 2 can for instance be a so-called electronic rear mirror or a parking assistance system or any other system. It can also be configured in the interior space for capturing a person, in particular a driver of the vehicle.

In FIG. 2 in an exploded view a known camera 4 is shown. The camera 4 comprises a lens module 9. The lens module 9 comprises a lens carrier 10, which is configured to be tubelike and in the embodiment has a mushroom-type shape on the outside. For this purpose the lens carrier 10 viewed in the direction of a longitudinal axis A of the camera 4 comprises a rear first tube part 11 with a first diameter. Viewed in axial direction and thus in the direction of the longitudinal axis A adjoining towards the front the lens carrier 10 comprises a front second tube part 12, which has a larger diameter than the first tube part 11.

Moreover, the camera 4 comprises a housing top part 15. The housing top part 15 is integral part of the external housing of the camera 4 so that the housing top part 15 represents an external part of the camera 4. The housing top part 15 comprises a basic body 16, which comprises a cornered, in particular a square outer geometry. In particular also an inner geometry of this basic body 16 is of such cornered design. In axial direction the housing top part 15 also comprises a tubelike attachment 17, which is configured to be directly adjoining and integrally formed with the basic body 16. This tubelike attachment 17 is configured in the embodiment as ring and thus has a cornerless outer geometry and in particular also a cornerless inner geometry.

Moreover, for the further representation of additional components of the camera 4 additionally a first interconnect device 18 and a second interconnect device 19, which is separate therefrom, are shown, which in the presented embodiment in the mounted final state are arranged within the housing top part 15. On one of the interconnect devices, in particular the interconnect device 18, at least one imager 20 is arranged, on which light rays incident through the lens module 9 are focussed.

Moreover, the camera 4 comprises a housing bottom part 21, which is separate from the housing top part 15 and which in the embodiment is of a plate-type design and thus represents a rear end of the external housing.

Moreover, it is envisaged that in the shown embodiment moreover a plug housing 22 is provided, which in axial direction is arranged adjoining to the housing bottom part 21 and which is configured for receiving an electrical plug, which then is electrically connectable to the counter contacting in the camera 4.

The lens module 9 moreover comprises a separate end ring 23, which is integrally formed, in particular made of aluminium. It is provided with an internal thread 24, whereby it is capable of being screwed upon the external thread 14 on the external surface 13. The end ring 23 in particular holds an external lens element 25 (FIG. 3) of a lens arrangement 26 in position. In the lens carrier 10 at least one seal 27 is arranged. Moreover, it is also envisaged that a further seal 28 (FIG. 2) is arranged between the housing bottom part 21 and the plug housing 22. Thereby a passage 30 is sealed, through which a pinlike component 29, which is positioned on the interconnect device, in particular on the interconnect device 19, extends.

As to FIG. 3 in a sectional view an embodiment of a camera 4 according to the invention and in an exploded view the single-piece component comprising the lens carrier 10 and the housing top part 15, as well as the end ring 23, which is separate therefrom and exemplary lenses of the lens arrangement 26 as well as the lens 25 arranged most outwardly is shown. In FIG. 3 not all components of the camera 4 are shown.

In the lens carrier 10 in the embodiment several lenses are inserted and received therein as optically imaging elements. The lens carrier 10 and the housing top part 15 integrally formed with it are in particular formed from aluminium.

As can be seen, on the external surface 13 of the housing top part 15 and thus also on the single-piece component comprising the lens carrier 10 and the housing top part 15 a fastening structure 14 is configured, which in the embodiment is an external thread.

The lenses of the lens arrangement 26, as they are shown in FIG. 3 on the left side, can be inserted into the lens carrier 10 from behind. The external lens element 25 in this embodiment is inserted from the right and thus from the front. This front lens element 25 is axially held by the end ring 23.

It may also be envisaged that all lenses of the lens arrangement 26 and thus also the external lens element 25 can be inserted and mounted from behind and thus in FIG. 3 from the left into the lens carrier 10. For this purpose an additional positioning element can be envisaged, which is an element that forms the rear end, which is preferably screwed into the housing top part 15 from behind, or fixed at the rear end of the lens carrier 10. This embodiment is shown in FIG. 4 in a sectional view. The positioning element 31 is shown. Here, too, at least between several lens elements of the lens arrangement 26, as well as in FIG. 3, distance elements 32 are arranged.

In the embodiment in FIG. 4 the end ring 23 is integrally formed with the housing top part 15. It is radially protruding into a channel 33. In the channel 33 of the lens carrier 10 the lens arrangement 26 is arranged. The protruding into the channel 33 is such that the front lens element 25 cannot slip out axially towards the front from the channel 33. For this purpose the end ring 23 comprises a protrusion 34.

In FIG. 5 an exploded view of an embodiment of a camera 4 according to the invention is shown. This comprises the housing top part 15 with the integrated lens carrier 10. The lens elements of the lens arrangement 26 are arranged therein. An interconnect device 18, a seal 35, a housing bottom part 21, and screws for screwing the housing top part 15 together with the housing bottom part 21 are shown. The housing top part 15 and the housing bottom part 21 are configured as external housing.

The lens elements with the lens element 25 of the lens arrangement 26 are thus arranged without additional, separate carrier sleeve in the housing top part 15. These lens elements thus are directly inserted into the housing top part 15.

1. A camera for a motor vehicle, comprising:
an external housing, which comprises a housing top part, in which a lens module of the camera is received,
wherein the lens module comprises a tubelike lens carrier, which is configured to be integrally formed with the housing top part.

2. The camera according to claim 1, wherein the integrally formed component comprising the tubelike lens carrier and the housing top part is configured as metal injection-moulded component.

3. The camera according to claim 1, wherein the lens module comprises a separate end ring.

4. The camera according to claim 3, wherein the end ring has an internal thread, which is configured for screwing together with an external thread on an external surface of the single-piece component comprising the lens carrier and the housing top part.

5. The camera according to claim 3, wherein the end ring is formed from aluminium.

6. The camera according to claim 3, wherein the end ring is integrally formed with the housing top part.

7. The camera according to claim 1, wherein the single-piece component comprises the housing top part and the lens carrier is made from aluminium.

8. The camera according to claim 1, wherein the lens carrier comprises a rear tube part with a first diameter, and axially adjoining a front tube part with a second diameter that is larger than the first diameter, and the fastening structure is formed on an external surface of the second tube part.

9. The camera according to claim 1, wherein the external housing comprises a housing bottom part separate from a housing top part, which is connected with the housing top part.

10. The camera according to claim 1, wherein the housing top part comprises a basic body and an adjoining tubelike attachment, and the lens carrier extends both in the basic body as well as in the tubelike attachment.

11. A motor vehicle with a camera according to claim 1.

12. A method for manufacturing a camera for a motor vehicle, comprising:
configuring the camera with an external housing, which is manufactured to comprise a housing top part; and
introducing a lens module of the camera into the housing top part,
wherein the lens module comprises a tubelike lens carrier configured to be integrally formed with the housing top part.
